(19) United States
(12) Patent Application Publication
(10) Pub. No.: US 2013/0013966 A1
(43) Pub. Date: Jan. 10, 2013

(54) ELECTRONIC APPARATUS, CONTROL METHOD AND COMPUTER-READABLE STORAGE MEDIUM

(76) Inventor: Hiroyuki Nakamoto, Kumagaya-shi (JP)

(21) Appl. No.: 13/450,161

(22) Filed: Apr. 18, 2012

(30) Foreign Application Priority Data
Jul. 5, 2011 (JP) 2011-149601

(51) Int. Cl. G06F 11/07

(52) U.S. Cl. 714/54; 714/E11.024

(57) ABSTRACT

An electronic apparatus includes an error detection times acquiring module and a waiting module. The error detection times acquiring module acquires the number of reading error detection times of a program according to a power-ON instruction instructing a power-ON operation, the number of error detection times being stored in a storage module. The waiting module waits for a reception of data capable of recognizing a communication counterpart device when the number of error detection times is more than a predetermined value by comparing the acquired number of error detection times with the predetermined value.

### CROSS REFERENCE TO RELATED APPLICATION(S)

The present disclosure relates to the subject matters contained in Japanese Patent Application No. 2011-149601 filed on Jul. 5, 2011, which are incorporated herein by reference in its entirety.

### FIELD

One or more embodiments of the present invention relate to an electronic apparatus, a control method of the electronic apparatus, and a computer-readable storage medium.

### BACKGROUND

In recent years, electronic apparatuses such as a television have been distributed and the operations of the electronic apparatuses have been controlled by software (programs) in many cases. For example, the cases in which the software (programs) is used for booting the electronic apparatuses have increased.

In general, the software (programs) is stored in a storage module, and read and executed during the booting operation.

When the software (programs) has an error due to unforeseen reasons, for example, a user himself may update and restore the software (programs) stored in the storage module, in a personal computer (PC).

However, it is inconvenient for the user of the electronic apparatus such as the television to perform the update by himself.

As a result, an electronic apparatus capable of conveniently performing the update when the software (programs) has an error has been needed.

### BRIEF DESCRIPTION OF THE DRAWINGS

A general configuration that implements the various features of the invention will be described with reference to the drawings. The drawings and the associated descriptions are provided to illustrate embodiments of the

FIG. 1 is a system diagram of a communication system (LAN) in which an external electronic device (PC) transmits data to an electronic apparatus (television) according to an embodiment so that the electronic apparatus can recognize the external electronic device (PC).

FIG. 2 is a block diagram showing an exemplary configuration of the electronic apparatus according to an embodiment.

FIG. 3 is a flowchart describing a power-on operation of an electronic apparatus according to an embodiment.

FIG. 4 is a flowchart describing an update operation of an application program in the electronic apparatus according to an embodiment.

FIG. 5 is a system diagram of another communication system (LAN) in which an external electronic device (BD player) transmits data to an electronic apparatus (television) according to an embodiment so that the electronic apparatus can recognize the external electronic device (BD player).

FIG. 6 is a system diagram of another communication system (LAN) in which an external electronic device (server) transmits data to an electronic apparatus (television) according to an embodiment so that the electronic apparatus can recognize the external electronic device (server).

### DETAILED DESCRIPTION OF THE EMBODIMENTS

According to one embodiment, an electronic apparatus includes an error detection times acquiring module and a waiting module. The error detection times acquiring module acquires the number of reading error detection times of a program according to a power-ON instruction instructing a power-ON operation, the number of error detection times being stored in a storage module. The waiting module waits for a reception of data capable of recognizing a communication counterpart device when the number of error detection times is more than a predetermined value by comparing the acquired number of error detection times with the predetermined value.

Hereinafter, embodiments will be described with reference to the accompanying drawings.

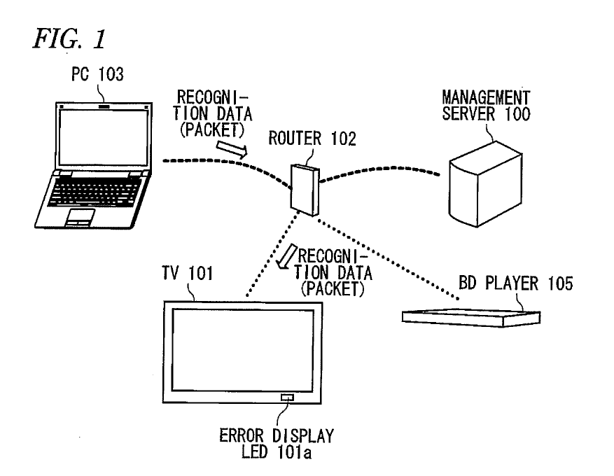

FIG. 1 is a system diagram of a communication system in which an external electronic device (PC) transmits data to an electronic apparatus (television) according to an embodiment so that the electronic apparatus can recognize the external electronic device (PC).

As shown in FIG. 1, in the embodiment, for example, an electronic apparatus (TV) 101, an electronic device (PC) 103, another electronic device (BD player) 105, and a management server 100 are connected to the LAN through a router 102.

Herein, the LAN is an abbreviation of a local area network and, for example, represents a computer network used in a single facility scale. The LAN is widely used at home, in offices of companies, laboratories and factories.

In the embodiment, for example, power-on of the TV 101 (booting) is instructed by a user who operates a remote controller (not shown).

For example, as described above, the TV 101 connected to a communication line such as the LAN acquires the number of reading error detection times of software (application program) stored in a storage module according to the power-on instruction.

Herein, the number of reading error detection times of the software will be described.

In the embodiment, for example, in booting the TV 101, when reading the application program stored in the storage module fails, the number of times is counted in each case and added up as the number of reading error detection times, for example, to be stored in the storage module.

For example, when a flash memory is used as the storage module, an error detection correcting technique such as ECC (alternatively, an error detection correcting technique) is used. However, if the error correction is not sufficient due to certain reasons, the application program stored in the storage module may be damaged.

In order to deal with the problem, the acquired number of error detection times is compared with a predetermined value and when the number of error detection times is more than the predetermined value, the TV 101 waits for a reception of recognition data that can recognize a communication counterpart device of the LAN communication line.

The predetermined value is stored, for example, in the storage module. The predetermined value is, for example, four times as described below.

In the embodiment, when the TV 101 is not normally booted, the TV 101 displays an error display LED 101a. For example, the TV 101 waits for the recognition data (to be described below) transmitted from the external device connected with the LAN.

The TV 101 transmits, for example, information (identification information) that enables the TV 101 itself to be identified to the external device (for example, the PC 103) that transmitted the recognition data. The information may be stored in the storage module 16 of the flash memory 15 in advance.

The information that enables the TV 101 itself to be identified is, for example, a model ID or a module ID. For example, the model of the TV 101 may be specified by the model ID. For example, although different application programs may be adopted in the same model of the TV, the different application programs in the same model may be extracted by the module ID.

The PC 103 acquires an updating application program suitable for the TV 101 from, for example, the Internet by using the information that enables the TV 101 itself to be identified. Thereafter, the external PC 103 transmits the obtained updating application program to the TV 101.

The TV 101 receives the updating application program suitable for the TV 101. The application program stored in the storage module (for example, the storage module 16 of the flash memory 15) of the TV 101 is updated.

In FIG. 1, the data (recognition data) capable of recognizing the communication counterpart device (PC 103) in the LAN communication line transmitted from the external PC 103 is received by the TV 101 through the router 102.

The recognition data may be transmitted by using a magic packet (packet) such as, for example, a wake-on-LAN (WOL).

Herein, the WOL is a technique that remotely controls the operation (supply or shut-down) of the power of a computer that is connected to a computer network (primarily, a LAN).

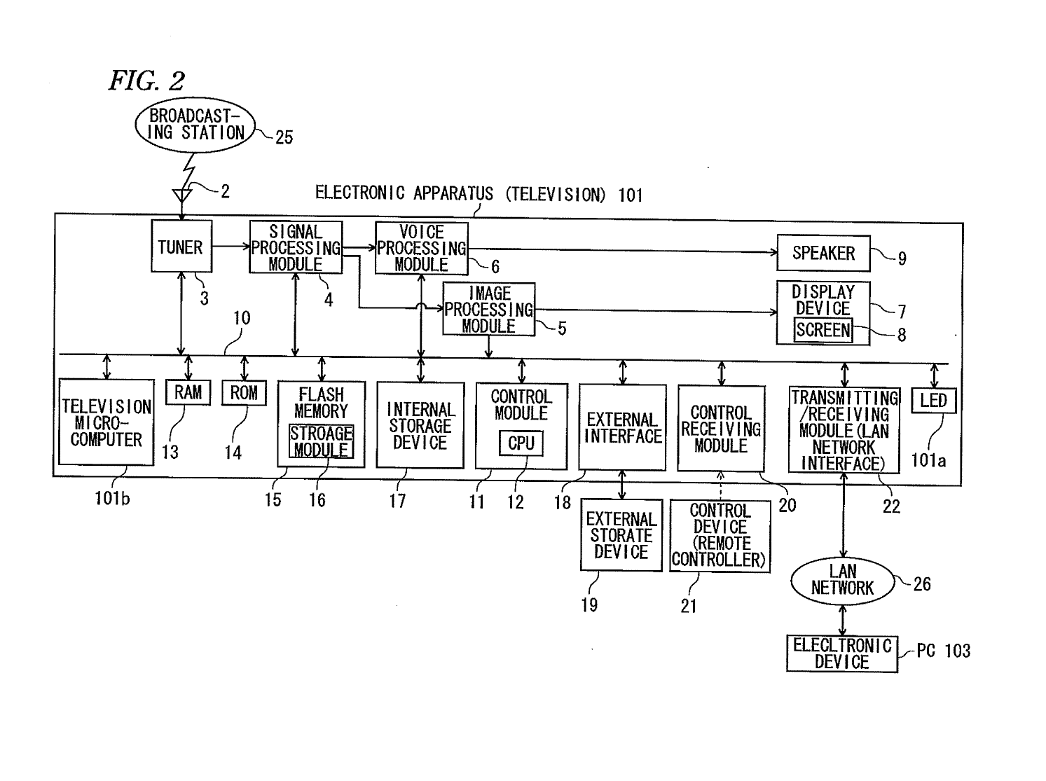

FIG. 2 is a block diagram showing an exemplary configuration of the electronic apparatus according to an embodiment of the present invention.

Reference numeral 2 represents an antenna, reference numeral 3 represents a tuner, reference numeral 4 represents a signal processing module, reference numeral 5 represents an image processing module, reference numeral 6 represents a voice processing module, reference numeral 7 represents a display device, reference numeral 8 represents a display screen (image displaying module), reference numeral 9 represents a speaker, reference numeral 10 represents a bus, reference numeral 11 represents a control module, reference numeral 12 represents a CPU, reference numeral 13 represents a RAM, reference numeral 14 represents a ROM, reference numeral 15 represents a flash memory, reference numeral 16 represents a storage module, reference numeral 17 represents an internal recording device, and reference numeral 18 represents an external interface. Reference numeral 19 represents an external storage device that is connected to the external interface.

Reference numeral 20 represents a control receiving module, reference numeral 21 represents a remote controller, reference numeral 22 represents a transmitting/receiving module (a network interface), reference numeral 25 represents a broadcasting station, reference numeral 26 represents a network (Internet), and reference numeral 103 represents an electronic device (PC).

Herein, the control module 11 includes the CPU 12 and controls the TV 101. The RAM 13, the ROM 14, and the flash memory 15 are used for, for example, the processing operation performed in the control module 11.

For example, image contents are broadcasted from the broadcasting station 25 through a digital broadcast. The digital broadcast broadcasted from the broadcasting station 25 is received by the tuner 3, and channel-tuned in the tuner 3, such that a digital signal of image contents are transmitted to the signal processing module 4.

The digital signal of image contents received by the signal processing module 4 are signal-processed to be transmitted to the voice processing module 6 and the image processing module 5.

The voice processing module 6 receives the signal-processed image contents and transmits the voice-processed signal to the speaker 9.

The speaker 9 receives the voice-processed signal and outputs a voice.

The image processing module 5 receives the signal-processed image contents and transmits the image-processed signal to the display device 7.

The display device 7 receives the image-processed signal and displays an image on the display screen (image displaying module 8) that is constituted by an LCD panel.

In the embodiment, the electronic apparatus (television) 101 includes the internal recording device 17 and may record the received image contents.

In the embodiment, the electronic apparatus (television) 101 includes the external storage device 19 connected with a USB or the LAN as described above. The received image contents may be recorded in the external storage device 19.

A user's control of the TV 101 is instructed by a control device such as, for example, the remote controller 21.

The processing operation is controlled by the control module 11.

As described above, the TV 101 is connected to the PC 103 from the transmitting/receiving module (the LAN network interface 22) through the LAN network 26.

In the embodiment, the TV 101 includes a television micro-computer 101b and an error display LED 101a as shown in FIG. 2.

As described above, for example, the TV 101 performs a booting operation by software.

In the embodiment, for example, the CPU 12 of the control module 11 operates the application program stored in the storage module 16 of the flash memory 15 to perform the booting operation of the TV 101.

However, as described above, for example, when a problem occurs due to the software (the application program stored in the storage module 16 of the flash memory 15), the TV 101 may not be normally booted.

As a result, in the embodiment, the television micro-computer 101b is provided.

That is, when the television micro-computer 101b receives the power-ON instruction of the TV 101 by the user's controlling of the remote controller 21, the television micro-computer 101b acquires the number of reading error detection times of the application program stored in the storage module 16 of the flash memory 15.

The television micro-computer 101b compares the number of error detection times which is acquired with the predetermined (stored) value in the storage module 16 of the flash memory 15. When the number of error detection times is more than the predetermined value, the television micro-computer 101b instructs to wait for the reception of the recognition data capable of recognizing the communication counterpart device.

As described above, the TV 101 includes the error display LED 101a.

The error display LED 101a displays an error according to the instruction from the television micro-computer 101b, for example, when the TV 101 is not normally booted. When the number of error detection times is more than the predetermined value, the TV 101 is not booted readily.

The television micro-computer 101b instructs the TV 101 to stop the power-ON operation (booting of the TV 101) when the number of error detection times is more than the predetermined value.

The television micro-computer 101b instructs the power-ON operation to be performed when the number of error detection times is not more than the predetermined value.

Herein, the application program used in the electronic apparatus according to the embodiment will be described.

As described above, the application program is stored in, for example, the storage module 16 of the flash memory 15.

Although not particularly shown, the application program includes flag data (flag signal) for detecting whether the application program is consistent.

In the embodiment, for example, the flag signal is detected according to the instruction from the television micro-computer 101b.

For example, the television micro-computer 101b instructs the TV 101 to detect whether the application program is consistent by comparing the flag signal included in the application program with, for example, a flag value that is predetermined (stored) in the storage module 16 of the flash memory 15.

The television micro-computer 101b instructs the TV to detect whether the flag signal included in the application program (program) is consistent when the number of error detection times is not more than the predetermined value.

When it is detected that the flag signal is not consistent, the television micro-computer 101b instructs the TV 101 to store the number of inconsistency times in the storage module 16 of the flash memory 15.

The television micro-computer 101b instructs the TV 101 to receive the updating application program transmitted from the communication counterpart device and update the application program stored in the storage module 16 of the flash memory 15 when the number of error detection times is more than the predetermined value.

The television micro-computer 101b instructs the TV 101 to transmit the information that enables the TV 101 itself to be identified to the communication counterpart device, receive the updating application program transmitted from the communication counterpart device receiving the information that enables the TV 101 itself to be identified, and update the application program stored in the storage module.

The communication counterpart apparatus acquires the updating application program of the TV 101 based on the information that enables the TV 101 itself to be identified.

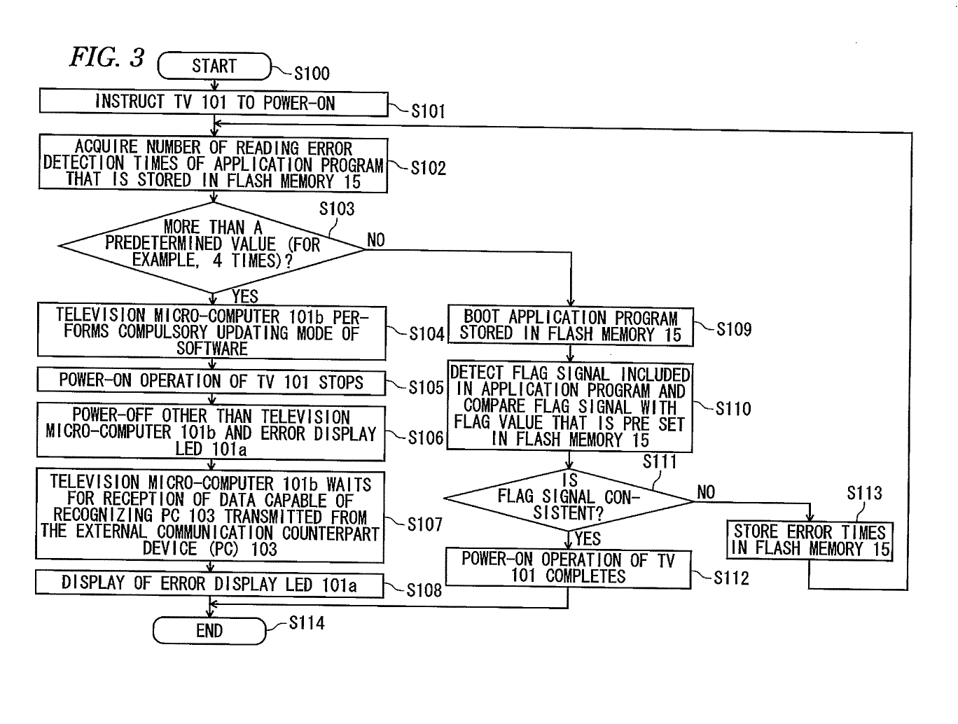

FIG. 3 is a flowchart illustrating a power-ON operation of an electronic apparatus according to an embodiment.

Step S100 is a start step herein. Continuously, the process proceeds to step S101.

At step S101, the TV 101 receives a power-ON instruction as described above. Continuously, the process proceeds to step S102.

At step S102, for example, information regarding the number of reading error detection times of an application program, which is stored in a flash memory 15, is acquired. Continuously, the process proceeds to step S103.

At step S103, it is determined whether the acquired information regarding the number of reading error detection times of the application program is more than a predetermined value. The predetermined value is, for example, four times herein. When it is determined that the acquired information regarding the number of reading error detection times of application program is more than the predetermined value (“Yes”), the process proceeds to step S104. When it is determined that the acquired information on the number of reading error detection times of the application program is not more than the predetermined value (“No”), the process proceeds to step S109.

At step S104, for example, a television micro-computer 101b performs a compulsory updating mode of the software. Continuously, the process proceeds to step S105.

At step S105, the power-ON operation of the TV 101 stops. Continuously, the process proceeds to step S106.

At step S106, for example, components other than the television micro-computer 101b and an error display LED 101a are powered off. Continuously, the process proceeds to step S107.

At step S107, the television micro-computer 101b waits for the reception of the data capable of recognizing the PC 103 transmitted from the PC 103 (an external communication counterpart device). Continuously, the process proceeds to step S108.

At step S108, a display of the error display LED 101a is outputted as described above. Continuously, the process proceeds to step S114.

At step S109, the application program stored in the flash memory 15 is booted. Continuously, the process proceeds to step S110.

At step S110, a flat signal included in the application program is detected and compared with a predetermined flag value stored in the flash memory 15. Continuously, the process proceeds to step S111.

At step S111, it is determined whether the flag signal included in the application program is consistent. When it is determined that the flag signal is consistent (“Yes”), the process proceeds to step S112. When it is determined that the flag signal is not consistent (“No”), the process proceeds to step S113.

At step S112, the power-ON operation of the TV 101 completes. Continuously, the process proceeds to step S114.

At step S113, the number of error times is stored in a storage module 16 of the flash memory 15. Continuously, the process proceeds to step S102 to repeat the above processes.

Step S114 is an end step and the processing herein ends.

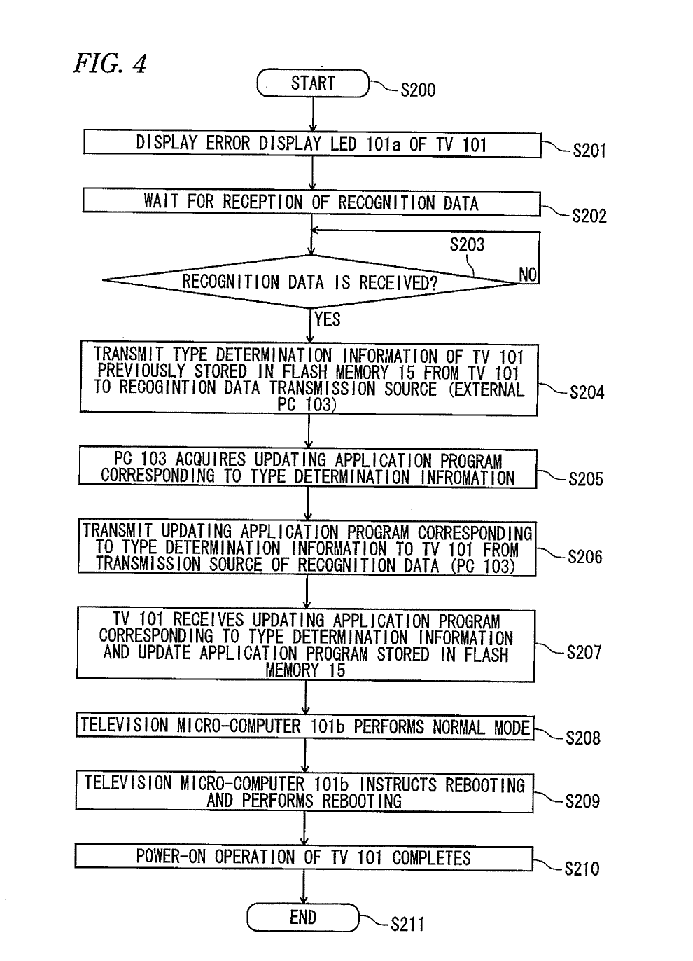

FIG. 4 is a flowchart illustrating an update processing operation of an application program in the electronic apparatus according to an embodiment.

Step S200 is a start step herein. Continuously, the process proceeds to step S201.

At step S201, the error display LED 101a of the TV 101 is displayed. Continuously, the process proceeds to step S202.

At step S202, the TV 101 waits for the reception of the recognition data transmitted from an external electronic device. Continuously, the process proceeds to step S203.

At step S203, it is determined whether the recognition data is received. When it is determined that the recognition data is received (“Yes”), the process proceeds to step S204. When it is determined that the recognition is not received (“No”), the processing herein is repeated.

At step S204, type determination information of the TV 101 previously stored in the storage module 16 of the flash memory 15 is transmitted to a transmission source (for example, the external PC 103) of the recognition data from the TV 101. The type determination information is, for example, a model ID or a module ID. Continuously, the process proceeds to step S205.

At step S205, the external PC 103 acquires an updating application program corresponding to the type determination information. Continuously, the process proceeds to step S206.

At step S206, the updating application program corresponding to the type determination information is transmitted to the TV 101 from the external PC 103 (transmission source) of the recognition data. Continuously, the process proceeds to step S207.

At step S207, the TV 101 receives the updating application program corresponding to the type determination information to update the application program stored in the storage module 16 of the flash memory 15. Continuously, the process proceeds to step S208.

At step S208, the television micro-computer 101b performs a transition to a general mode. Continuously, the process proceeds to step S209.

At step S209, for example, the control module 11 instructs the television micro-computer 101b to perform a rebooting. Continuously, the process proceeds to step S210.

At step S210, the power-ON operation of the TV 101 completes. Continuously, the process proceeds to step S211.

Step S211 is the end step and the processing herein ends.

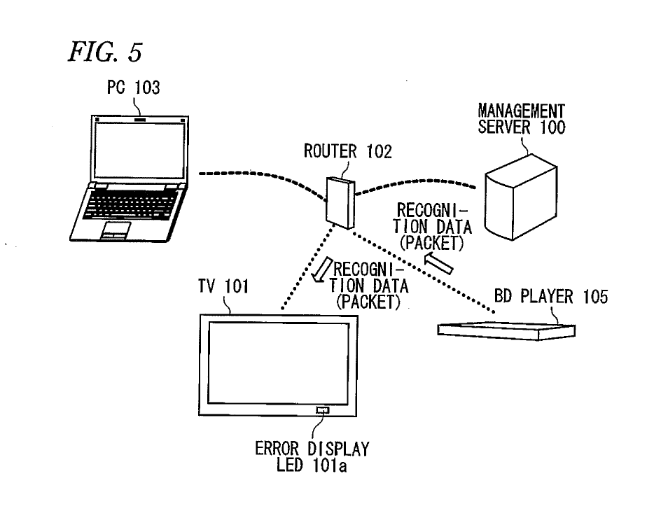

FIG. 5 is a system diagram of another communication system (LAN) in which an external electronic device (BD player) transmits data to an electronic apparatus (television) according to an embodiment so that the electronic apparatus can recognize the external electronic device (BD player).

In the embodiment, similarly to FIG. 1, the TV 101, the PC 103, the BD player 105, and a management server 100 are connected to the LAN through a router 102.

In the embodiment, the updating application program is acquired from the BD player 105.

As described above, the TV 101 displays the error display LED 101a when the TV 101 is not normally booted, and, for example, wait for the recognition data transmitted from the BD player 105 connected with the LAN.

The TV 101 having received the recognition data transmits the information (model ID or module ID) that enables the TV 101 itself to be identified to the external BD player 105.

The external BD player 105 having received the information that enables the TV 101 itself to be identified acquires an updating application program suitable for the TV 101 through, for example, the Internet by using the information, and transmits the acquired updating application program to the TV 101.

The TV 101 receives the updating application program to update the application program stored in the storage module (for example, the storage module 16 of the flash memory 15) of the TV 101.

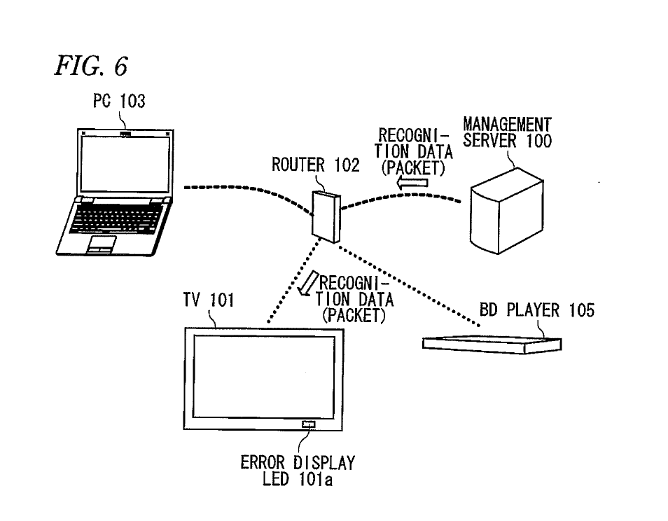

FIG. 6 is a system diagram of another communication system (LAN) in which an external electronic device (server) transmits data to an electronic apparatus (television) according to an embodiment so that the electronic apparatus can recognize the external electronic device (server).

In the embodiment, similarly to FIG. 1, the TV 101, the PC 103, the BD player 105, and the management server 100 are connected to the LAN through the router 102.

In the embodiment, the updating application program is acquired from the external management server 100.

As described above, the TV 101 displays the error display LED 101a when the TV 101 is not normally booted, and, for example, waits for the recognition data transmitted from the external management server 100 connected with the LAN.

The TV 101 having received the recognition data transmits the information (model ID or module ID) that enables the TV 101 itself to be identified to the external BD player 105.

The external management server 100 having received the information that enables the TV 101 itself to be identified acquires the updating application program suitable for the TV 101 through, for example, the Internet by using the information and transmits the acquired updating application program to the TV 101.

The TV 101 receives the updating application program to update the application program stored in the storage module (for example, the storage module 16 of the flash memory 15) of the TV 101.

By the above configuration, in the embodiment, for example, when the software (programs) has an error, an electronic apparatus can conveniently perform the update processing.

When the booting operation of the electronic apparatus has an error due to an error of the software (program), the electronic apparatus can be conveniently restored.

All sequences of the control processing of the embodiment may be executed by the software. Therefore, just by installing and executing the program in the general computer through a computer readable storage medium storing the program that executes the sequences of the control processing, the same effect as the embodiment can be easily implemented.

The embodiment is not limited to a description itself, but in implementation steps, the components can be variously modified and embodied within the scope without departing from the spirit.

Various inventions may be formed by appropriate combinations of a plurality of components disclosed in the embodiments.

For example, some components may be deleted from all the components shown in the embodiments. Further, components of different embodiments may be appropriately combined with each other.

What is claimed is:

1. An electronic apparatus comprising:
an error detection times acquiring module configured to acquire the number of reading error detection times of a program according to a power-ON instruction instructing a power-ON operation, the number of error detection times being stored in a storage module; and
a waiting module configured to wait for a reception of data capable of recognizing a communication counterpart device when the number of error detection times is more than a predetermined value by comparing the acquired number of error detection times with the predetermined value.

2. The electronic apparatus of claim 1, further comprising a display module configured to display an error when the number of error detection times is more than the predetermined value.

3. The electronic apparatus of claim 1, wherein the power-ON operation stops when the number of error detection times is more than the predetermined value.

4. The electronic apparatus of claim 1, wherein the power-on operation is performed when the number of error detection times is not more than the predetermined value.

5. The electronic apparatus of claim 1, wherein it is detected whether a flag signal included in the program is consistent when the number of error detection times is not more than the predetermined value.

6. The electronic apparatus of claim 5, wherein the flag signal is detected by comparing the flag signal included in the program with a predetermined flag value.

7. The electronic apparatus of claim 1, wherein when the number of error detection times is not more than the predetermined value, it is detected whether a flag signal included in the program is consistent and when it is detected that the flag signal is not consistent, the number of inconsistency detection times is stored in the storage module.

8. The electronic apparatus of claim 1, wherein when the number of error detection times is more than the predetermined value, an updating program transmitted from the communication counterpart device is received to update the program stored in the storage module.

9. The electronic apparatus of claim 1, wherein
identification information that enables the electronic apparatus itself to be identified is transmitted to the communication counterpart device, and
an updating program transmitted from the communication counterpart device that has received the identification information is received to update the program stored in the storage module.

10. The electronic apparatus of claim 9, wherein the communication counterpart device acquires the updating program of the electronic apparatus based on the identification information.

11. A control method of an electronic apparatus, the method comprising:
acquiring the number of reading error detection times of a program according to a power-ON instruction, the number of reading error detection times stored in a storage module; and
waiting for a reception of data capable of recognizing a communication counterpart device when the number of error detection times is more than a predetermined value by comparing the acquired number of error detection times with the predetermined value.

12. A computer-readable storage medium storing a computer executable program that, when executed, causes a computer to perform:
acquiring the number of reading error detection times of a program according to a power-on instruction, the number of reading error detection times stored in a storage module; and
waiting for a reception of data capable of recognizing a communication counterpart device when the number of error detection times is more than a predetermined value by comparing the acquired number of error detection times with the predetermined value.
